(19) United States
(12) Patent Application Publication
(10) Pub. No.: US 2004/0128661 A1
(43) Pub. Date: Jul. 1, 2004

(54) Automatic data locality optimization for non-type-safe languages

(76) Inventors: Somnath Ghosh, Sunnyvale, CA (US); Rakesh Krishnaiyer, Santa Clara, CA (US); Wei Li, Redwood City, CA (US); David Sehr, Cupertino, CA (US)

Correspondence Address: Pillsbury Winthrop LLP, Intellectual Property Group, 725 South Figueroa St., Los Angeles, CA, 90017-5443, US

(21) Appl. No.: 10/331,947

(22) Filed: Dec. 31, 2002

(51) Int. Cl. G06F 9/45

(52) U.S. Cl. 717/159; 717/161; 717/151

(57) ABSTRACT

An arrangement is provided for optimizing data locality for efficient memory access in code written in a non-type-safe programming language. Candidate structures in the code qualified to be optimized are first identified. Data locality optimization is then performed on such identified structures based on field re-ordering and structure splitting.

### BACKGROUND

In developing software applications, objects have been used widely to aggregate different types of data or collections of objects called “fields” in a single structure. Structure objects tend to be large, often with many fields. In many applications, however, only a few fields are accessed frequently at run time while most of the fields are rarely accessed. The fields that are accessed frequently are called “hot” fields and the fields that are seldom accessed are called “cold” fields.

Due to the large number of fields in a single structure object, hot fields contained in different objects often reside far apart in memory. When cache space is limited, this often leads to high cache and translation lookaside buffer (TLB) misses and heavy cache pollution. Memory access latency is often a crucial factor in processing speed. High cache miss leads to frequent memory access, and ultimately, degradation in performance.

One solution to the problem is to place heavily accessed fields close together so that memory access yields mostly useful data into the cache. This may significantly reduce cache miss and memory accesses. Field re-ordering and structure splitting have been used to optimize structure layout to improve data locality of structure objects. Such techniques have been applied to type-safe languages such as Java. However, for non-type-safe languages such as C and C++, so far there has been no effective technique except manual approaches that require human intervention.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 depicts a data locality optimization mechanism that takes original code programmed in a non-type-safe language and optimizes the data locality for efficient memory access, according to embodiments of the inventions;

FIG. 2 depicts an exemplary internal structure of a data locality optimization mechanism, according to embodiments of the inventions;

FIG. 3 depicts an exemplary internal structure of a candidate structure identifier, according to embodiments of the inventions;

FIG. 4 describes exemplary types of criteria to be used in selecting a candidate structure for data locality optimization, according to embodiments of the inventions;

FIG. 5(a) depicts an exemplary internal structure of a static candidate structure profiling mechanism;

FIG. 5(b) depicts an exemplary internal structure of a dynamic candidate structure profiling mechanism;

FIG. 6 illustrates field re-ordering and structure splitting performed in data locality optimization;

FIG. 7 depicts an exemplary internal structure of a structure splitting mechanism, according to embodiments of the inventions;

FIG. 8 is a flowchart of an exemplary process, in which the data locality of original code is optimized to produce efficient object code, according to embodiments of the inventions;

FIG. 9 is a flowchart of an exemplary process, in which a candidate structure in original code is identified to be optimized, according to embodiments of the inventions;

FIG. 10 is a flowchart of an exemplary process, in which a candidate structure is split into more than one structure and original code is modified to reflect the structure change, according to embodiments of the inventions; and

FIGS. 11(a)-(b) depict different schemes in which data locality optimization is utilized in compiling original code programmed in a non-type-safe language, according to embodiments of the inventions.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

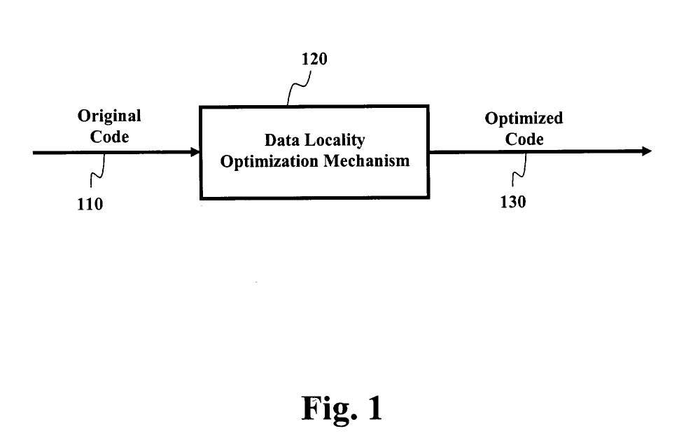

FIG. 1 depicts a data locality optimization mechanism 120 that takes original code 110 and optimizes the data locality for efficient memory access, according to embodiments of the inventions. The original code is programmed in a source code that is a non-type-safe programming language such as C++, Borland C, and C#. The data locality optimization mechanism 120 processes the original code 110, identifying candidate structures that can be optimized, optimizing the original code so that efficiency in memory access is optimized based on data locality of the structures, and produces optimized code 130.

The data locality optimization mechanism 120 performs optimization on structures defined in the original code 110. To optimize memory access of a structure, the data locality optimization mechanism 120 classifies the fields of the structure into different categories. For example, fields of a structure to be optimized may be classified into “hot” and “cold” categories. The former may indicate that an underlying field with that label is accessed quite frequently. The latter may indicate an infrequent access of a field. More categories (than two) may also be devised. Such classifications of the fields of a structure is called a profile. The classification operation may be called profiling.

To optimize memory access efficiency, the data locality optimization mechanism 120 re-orders or re-arranges the fields in the structure to be optimized according to the profile of the structure. The re-ordering is performed in such a manner so that fields with a same label are grouped together. This is to facilitate a structure splitting operation so that fields with similar access patterns can be accessed at the same time. To achieve that, the fields may be re-ordered based on the classification (or profile) of the fields. For instance, all the fields that are labeled as “hot” may be grouped together in a sequence. All the fields that are labeled as “cold” may be grouped together in a different group in a sequence.

To facilitate efficient memory access with respect to the memory access profile, the data locality optimization mechanism 120 further splits a structure to be optimized into several structures, each of which has a distinct memory access pattern. For instance, using the example of two categories of memory accessing pattern (i.e., “hot” and “cold”), a structure may be split into two structures, one containing the fields having access pattern of “hot” and the other containing the fields having access pattern of “cold”. Portions of the original code may then be automatically revised to reflect the changes made to the original structure.

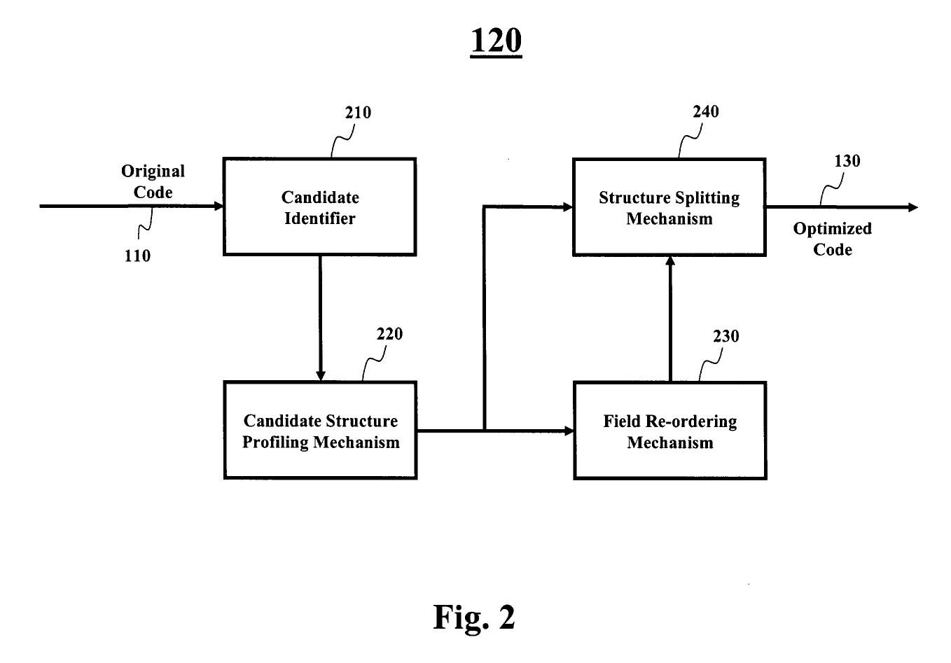

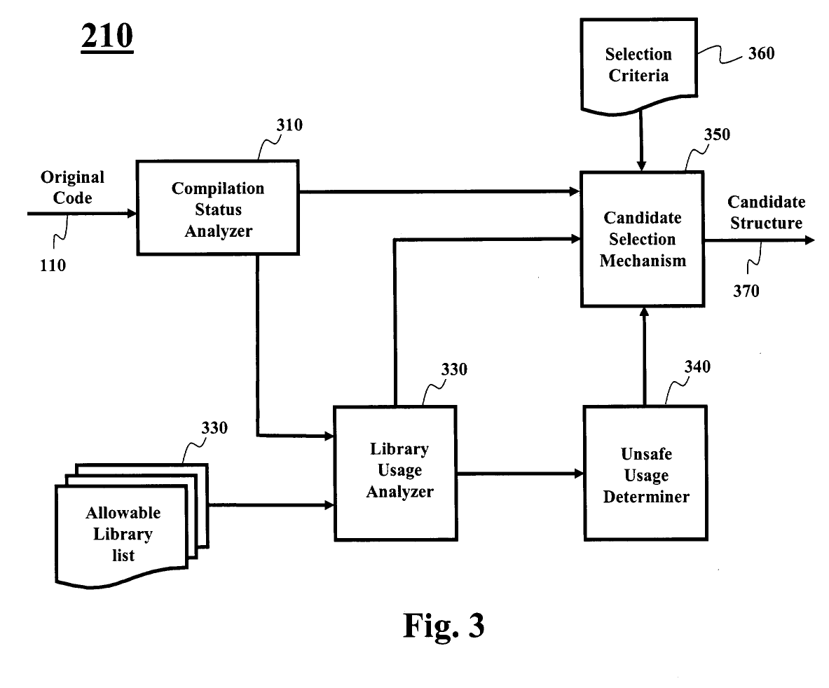

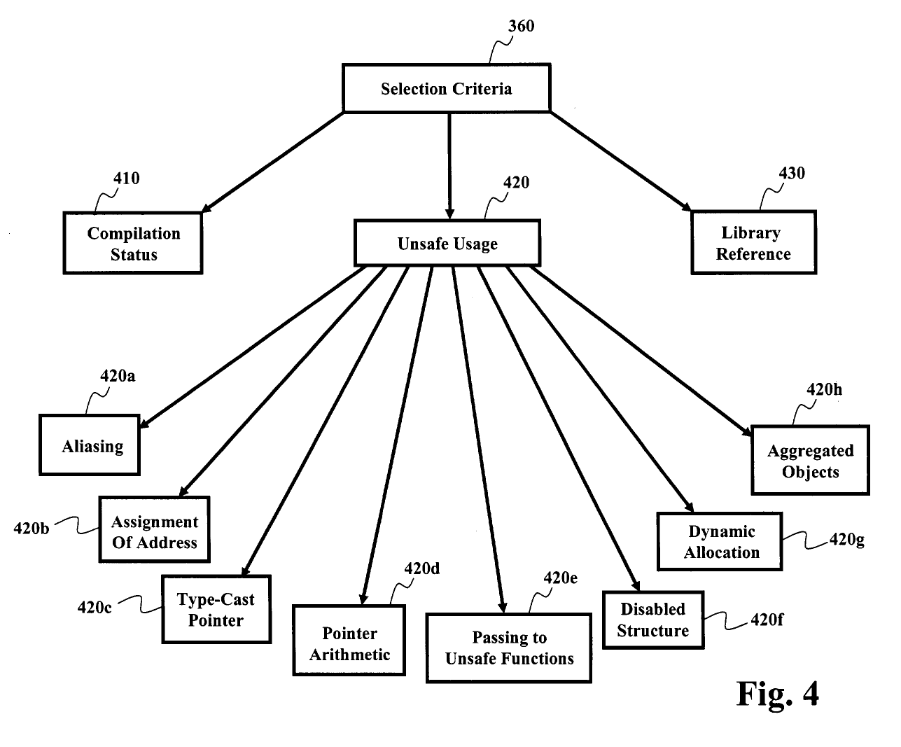

FIG. 2 depicts an exemplary internal structure of the data locality optimization mechanism 120, according to embodiments of the inventions. The data locality optimization mechanism 120 comprises a candidate structure identifier 210, a candidate structure profiling mechanism 220, a field re-ordering mechanism 230, and a structure splitting mechanism 240. The candidate structure identifier 210 determines whether the original code 110 may be optimized and if so, the specific structure(s) that can be optimized. Details about the candidate structure identifier 210 and how it may select a candidate structure are discussed with reference to FIGS. 3, 4, and 9.

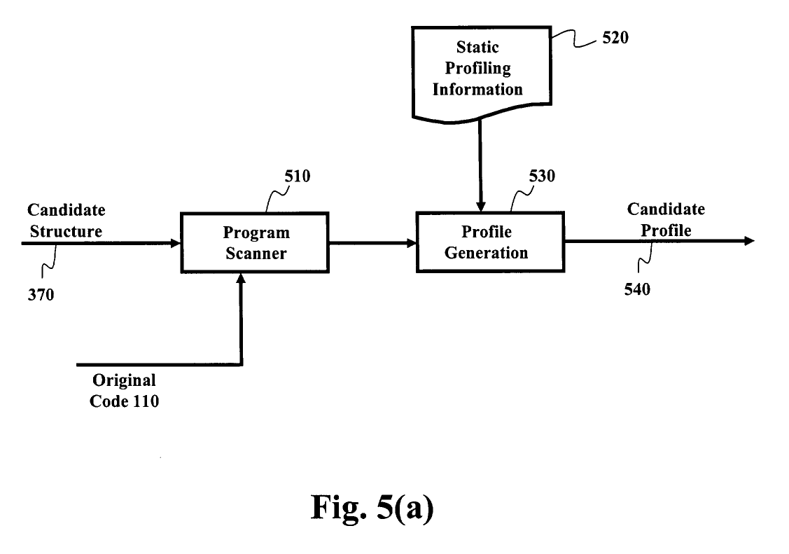

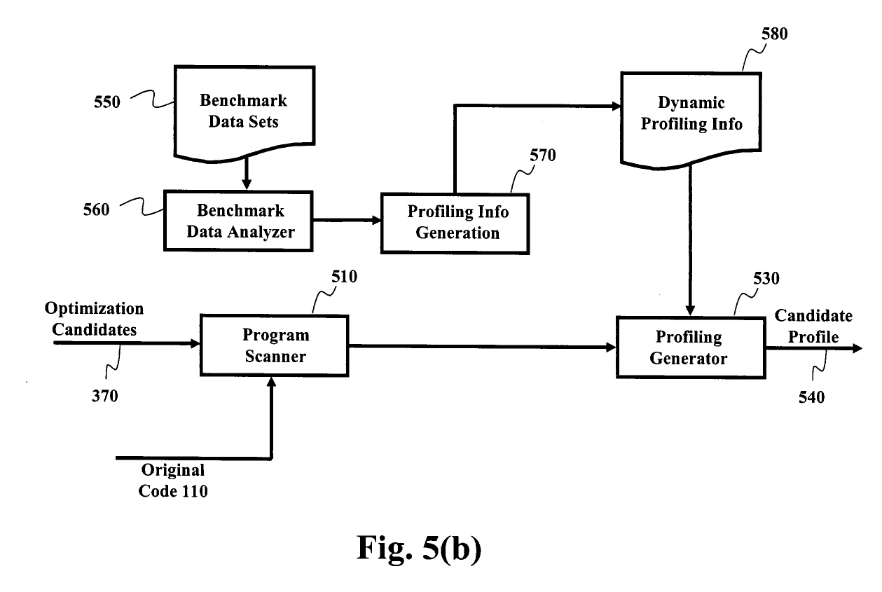

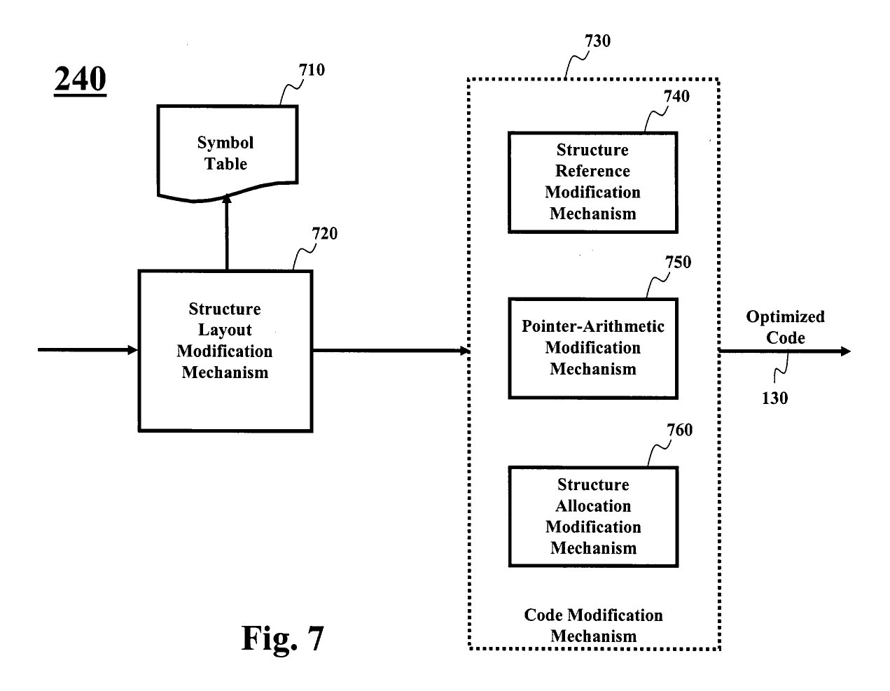

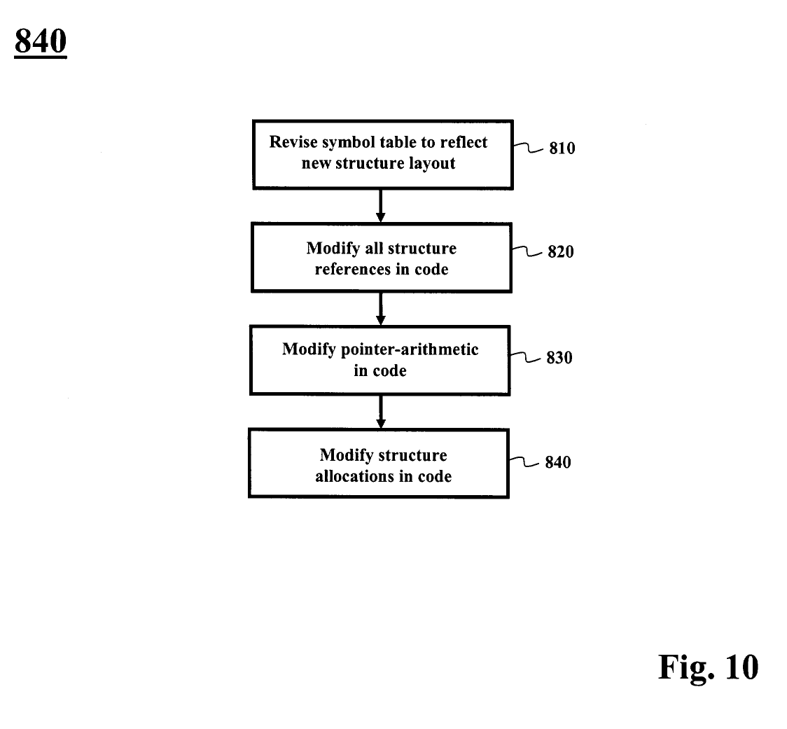

Based on identified structure(s) that can be optimized, the candidate profiling mechanism 220 perform operations to determine the profile for each candidate structure. Such profiling may be performed in either a static or a dynamic fashion. Details related to profiling are discussed with reference to FIG. 5. The field re-ordering mechanism 230 re-arranges the fields of a candidate structure based on the profile of the structure. The re-ordering produces an updated arrangement inside the structure, based on which the structure splitting mechanism 240 carries out necessary operations to split the original candidate structure into multiple ones and revise parts of the original code according to the new layout of the structures. Details related to structure splitting are discussed with reference to FIGS. 7 and 10.

FIG. 3 depicts an exemplary internal structure of the candidate structure identifier 210, which comprises a compilation status analyzer 310, a library usage analyzer 320, an unsafe usage determiner 340, and a candidate selection mechanism 350. To determine candidate structure(s) for optimization, there may be two levels of determination. First of all, the candidate structure identifier 210 determines whether the original code 110 can be safely optimized. Only when the original code 110 can be safely optimized, the candidate structure identifier 210 further identifies the structure(s) in the original code 110 that can be safely optimized to make memory access more efficient. For instance, when the original code 110 is to be partially compiled, it may not be possible at this point to optimize the memory access because there may be many parts of the code that will not be re-compiled. The compilation status analyzer 310 identifies how the original code 110 is to be compiled. When the original code 110 is to compiled partially (or so called delta compilation), the compilation status analyzer 310 may inform the candidate selection mechanism 350 the recognized status.

Another instance of a situation where the original code 110 may not be optimized is when the original code 110 uses is using some non-standard library. When a non-standard library is used, since a compiler will not be able to access the variables and functions defined in such a non-standard library, the data locality optimization may not be performed in a safe manner. In this case, the original code 110 may be considered as not suitable for data locality optimization. The library usage analyzer 320 is responsible for detecting any reference to a non-standard library cited in the original code 110. This may be achieved based on, for example, a list 330 of all standard (or allowed) libraries. The allowable library list 330 may be updated when the allowed library list expands or shrinks. When a non-standard library reference is found in the original code 110, the library usage analyzer 320 informs the candidate selection mechanism 350 of such identification.

Another level of determination in terms of which structure may be optimized has to do with whether the structure may be safely optimized. Compared with the determination of whether the original code 110 can be optimized, this level of determination focuses on specific structures. The determination is made based on more of a local consideration. In a non-type-safe (or weakly typed) language, there are multiple scenarios which may render data locality optimization unsafe or indeterminate. For instance, if a structure allows aliasing (i.e., more than one field refer to the same memory location), it may create problems if an attempt is made to optimize such a structure. As another example, if the address of a structure or a field of a structure is assigned to another variable, since optimization will change the address of the structure, the optimization can not performed safely.

The unsafe usage determiner 340 is responsible for detecting various types of unsafe usage of either the fields of a structure or a structure itself. When any instance of unsafe usage is detected, the unsafe usage determiner 340 reports the detection to the candidate selection mechanism 350 which ultimately determines whether a given structure can be safely optimized based on the detection results from the compilation status analyzer 310, the library usage analyzer 320, and the unsafe usage determiner 340. A determination is made with respect to a plurality of selection criteria 360, which are pre-defined and may be updated when needed.

FIG. 4 describes exemplary types of criteria to be used in selecting a candidate structure for data locality optimization, according to embodiments of the inventions. The selection criteria 360 may include criteria at both a global level (i.e., whether the original code 110 in its entirety can be considered to be optimized) and a local level (i.e., whether a specific structure within the original code 110 can be optimized). For example, in the illustration, the selection criteria 360 relate to compilation status 410 and library reference 430 at the global level, as well as any unsafe usage 420 at the local level. Specifically, at the local level, unsafe usage may include various scenarios in which unsafe usage of either the structure itself or its fields may render the optimization unsafe.

One scenario (420a) involves aliasing, in which more than one field refers to a same physical memory location. For example, in the weakly typed language C or C++, it is called a union. A different scenario (420b) may involve an assignment of either the address of a field of an underlying structure or the address of the structure itself to another variable. For example, if the original code 110 contains a statement like: “cp:=&x.cx;”, where x is a structure to be considered for optimization, cx is one of its fields, and cp is a variable. In this case, if the address of the structure changes, it may cause other unexpected effect on the original code 110. This uncertainty renders the optimization unsafe.

The next possible scenario (420c) involves a situation where the underlying structure can be accessed through pointers of other types (e.g., type-cast). For instance, if the original code 110 contains a statement such as “yp:=(struct SY *) &x;”, where x is the underlying structure and yp is a pointer to a different structure but type-cast to access structure x.

Another scenario (420d) is when some pointer arithmetic in the original code 110 involving a pointer to the underlying structure can lead to an address inside of the structure. For instance, statements “xp:=&x; n:=A[*((char *)xp+8)];” illustrate such a scenario, where the value of a pointer xp to an underlying structure x is used in some arithmetic whose computation result is used to access some internal field of the structure x. Due to the special relation, a change made to either the address of structure x or the layout of the structure x may render it impossible to achieve what was intended in the original code 110.

The next possible scenario (420e) involves passing a pointer to an underlying structure to an unsafe function. For example, statement “foo (. . . , &x, . . . );” passes the pointer to structure x to a function foo( ).An unsafe function for example could be a library function which is known to access structures in an unsafe manner. Another scenario (420f) involving unsafe usage is when an underlying structure or its pointer is passed to an already disabled structure. This can be illustrated in the statement “struct D {int a, struct x *b, . . . );”, where structure D is a disabled structure and structure x is the underlying structure. An unsafe access of structure x through a pointer to structure D would get undetected while analyzing just the program statements.

Another unsafe scenario (420g) is related to dynamic memory allocation. When a dynamic allocation uses the size of an underlying structure and the total size requested is not an integral multiple of the size of the structure, any change made to the underlying structure may cause unexpected effect in this allocation. For instance, given a dynamic allocation statement “xp:=(struct x *) malloc (sizeof (struct x)+50);”, the total size of memory requested is the size of structure x plus 50 units. In this case, if optimization changes the size of structure x, the size allocated will be different from what is intended in the original code 110. It is possible that in some situations, the change to structure x may not affect the outcome of this allocation statement. However, in general, it is unsafe to tamper with structure x when such usage of its size exists.

Another exemplary scenario (420h) involves array objects within an underlying structure. If the language allows out-of-bound accesses for array objects, it is considered unsafe to optimize a structure that has an array as a field. For example, if the program's intention is to access the next field of the array field by accessing the array, a layout change of the structure might provide wrong data to that access.

Specific criteria used in an implementation of the inventions may differ for various reasons. For example, depending on the underlying language used to develop the original code 110, different unsafe usage may emerge. Alternatively, some unsafe scenarios illustrated above may be considered safe in some implementations. Adoption of selection criterion may also depend on application needs. It should be appreciated by one skilled in the art that the criteria discussed are merely for illustration not as limitations. Specific variations may be called for in applying the concept discussed above.

FIG. 5(a) depicts an exemplary internal structure of a static candidate structure profiling mechanism as an implementation of the candidate structure profiling mechanism 220, which comprises a program scanner 510 and a profile generator 530. The program scanner 510 examines the original code 110 given a candidate structure. It may examine the structure of the original code 110 with respect to the given candidate structure. The characteristics of the original code 110 related to the candidate structure are sent to the profile generator 530. Taking the characterization of the program as input, the profile generator 530 consults with some pre-defined status profiling information 520 to determine the profile of the candidate structure.

The static profiling information 520 may provide guidelines in terms of how a structure should be profiled given some known characteristics of the structure. For instance, the static profiling information 520 may specify that if a particular field of a structure is involved in a loop, it should have a different access pattern (e.g., a higher access rate) than a field that is not involved in a loop. Such guidelines may be derived previously according to knowledge and experience and can be defined manually. Using static profiling information 520, the profile of a candidate structure (540) is determined according to the program structure of the original code 110.

FIG. 5(b) depicts an exemplary internal structure of a dynamic candidate structure profiling mechanism as a different implementation of the candidate structure profiling mechanism 220. The dynamic candidate structure profiling mechanism illustrated in FIG. 5(b) generates a profile of a candidate structure in a substantially similar manner as the mechanism illustrated in FIG. 5(a) except it determines the profile 540 based on dynamic (instead of static) profiling information 580.

The dynamic profiling information 580 also provides guidelines in terms of how a structure should be profiled given some known characteristics of the structure. The difference is how the dynamic profiling information is derived. The dynamic profiling information 580 may be obtained based on benchmark data 550. Such benchmark data sets may be collected in a way that it is representative to the underlying code to be optimized. Such benchmark data sets are analyzed by a benchmark data analyzer 560 that may obtain various statistics related to certain characteristics of the benchmark data. Such statistics may then be used by a profiling information generation mechanism 570 to derive the dynamic profiling information 580.

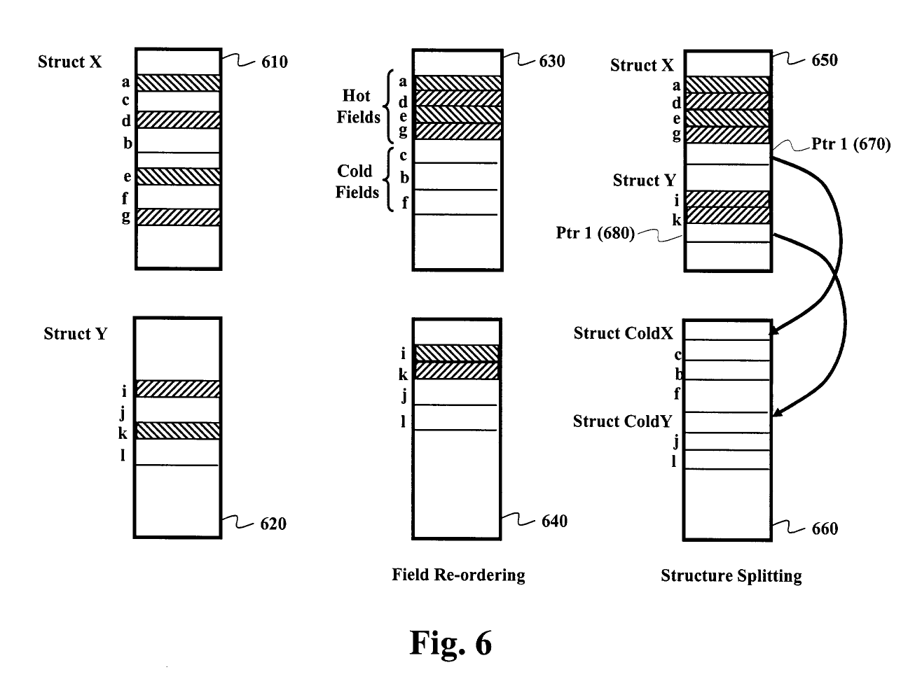

As described earlier, based on the profile of a candidate structure, optimization may be performed through field re-ordering and structure splitting. FIG. 6 illustrates field re-ordering and structure splitting operations. There are two structures X and Y, each of which has a plurality of fields. For example, structure X and structure Y may be defined as following, respectively.

```
struct X {
    int a;
    int b;
    char c, g;
    float d;
    char e, f;
} xp, *xp;
struct Y {
    int i;
    float j;
    binary k;
    char l;
} yp, *yp;
```

The left column of FIG. 6 visually illustrates the outcomes (610 and 620) of profiling performed on both structures. For example, if there are only two categories of memory access pattern (e.g., hot and cold) and a hot field is marked as shaded, FIG. 6 shows that fields a, d, e, and g of structure X are hot (in 610) and fields i and k of structure Y are hot (in 620). All other fields in both structures are cold.

The middle column of FIG. 6 illustrates how field re-ordering may take place in individual structures according to the profiling discussed above. Re-ordering groups together fields with a same access pattern in each structure. This is illustrated in 630 and 640, where hot fields a, d, e, and g of structure X are now grouped together in a sequence and cold fields c, b, and f are grouped together in a sequence following the hot fields. Similarly, in 640, hot fields i and k of structure Y are grouped in a sequence followed by cold fields j and k as a group. The sequence of the fields in each structure (630 and 640) is not the same as before (610 and 620) after the re-ordering and such grouping facilitates the next step: structure splitting.

The right most column (650 and 660) in FIG. 6 illustrates the structure splitting of structure X and structure Y. Each structure is split into two structures, one of which corresponds to a hot structure and the other corresponds to a cold structure. For example, structure X is now split into two structures: one is still named X and the other named, for instance, as ColdX. Similarly, structure Y is split into two structures: one is Y and the other ColdY. The structure with the same name as before (i.e., X and Y), does not have the same layout as the original structure. For example, after the split, structure X contains all the hot fields (i.e., fields a, d, e, and g) with an additional field that serves as a pointer (670) pointing to the associated structure ColdX (which contains cold fields c, b, and f). Structure Y, after the split, contains all its hot fields (i and k) with an additional pointer (680) pointing to its counterpart ColdY (with cold fields j and l).

According to the illustrated field re-ordering and structure splitting, the split structures of the above given example structure X and structure Y are generated as follows:

struct X {

```
    int a;
    float d;
    char e;
    char g;
    struct ColdX *cold; /* pointer to ColdX
} xp, *xp;
struct ColdX {
    char c;
    float d;
    char f;
} x_cold;
struct Y {
    int i;
    binary k;
    struct ColdY *cold; /* pointer to ColdX
} yp, *yp;
struct ColdY {
    float j;
    char l;
} y_cold;
```

FIG. 7 depicts an exemplary internal structure of the structure splitting mechanism 240, according to embodiments of the inventions. To fulfill the above mentioned operations in splitting a structure, the structure splitting mechanism 240 comprises a structure layout modification mechanism 720 and a code modification mechanism 730. The former is to modify the recording that describes the layout of an underlying structure. For example, the layout of all variables and structures of a program may be recorded in a symbol table (710). Such recording may contain information such as the address of a structure, the size of the structure, and all the fields defined in the structure. When the recorded structure is split, such recording needs to be modified accordingly to reflect the change.

In addition to modifying the recorded information related to a split structure, portions of the original code 110 may also need to be modified. For example, wherever a cold field of the underlying structure is referenced, the structure name referred to needs to be changed. In the exemplary embodiment described in FIG. 7, the code modification mechanism 730 comprises a structure reference modification mechanism 740, a pointer-arithmetic modification mechanism 750, and a structure allocation modification mechanism 760. The structure reference modification mechanism 740 changes a reference to a cold field of the underlying structure to a correct reference. For example, given the above mentioned example of structure X, an original reference in the original code 110 to a cold field of structure X such as xp→b is modified to reflect the structural change such as xp→cold→b.

The pointer-arithmetic modification mechanism 750 serves to modify, when necessary, the pointer arithmetic to reflect the new size of the underlying structure. For example, if the size of the original structure were 16 and the size of the new hot structure (with the same name) is 8, such change may need to be made in the pointer arithmetic involving the size of the structure. This modification operation may be optional, depending on whether the optimization is performed before or after the structure size is modified.

The structure allocation modification mechanism 760 is responsible for modifying the code related to allocating the underlying structure. Depending on whether the original allocation is a static, dynamic, or stack allocation, the modification may be different. For example, if it is a dynamic allocation, the size of the memory to be allocated may be changed to the cumulative size of the hot and cold structures. In addition, an assignment statement may be added that accordingly sets the pointer to the cold structure.

When an allocation is static, the hot and cold structures are actually allocated at linking time and such allocation will be performed according to the symbol table. Since the symbol table has been changed to reflect the new structure layout, the linker can properly allocate the required space. However, the pointer to a cold structure in a corresponding hot structure needs to be initialized to the address of the cold structure. At run-time, this address is a run-time constant. When an allocation is for a stack, a pointer to a cold structure in a corresponding hot structure is set at the beginning of a routine once the program allocates the stack space for the hot and cold structures according to the symbol table.

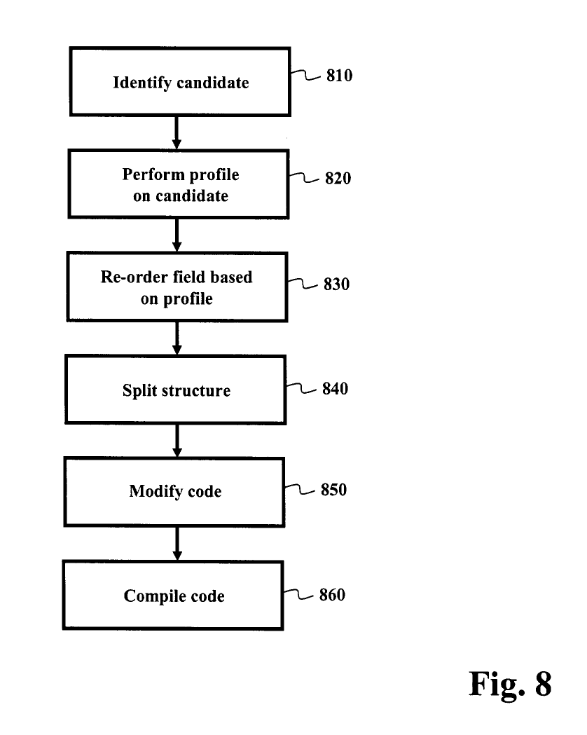

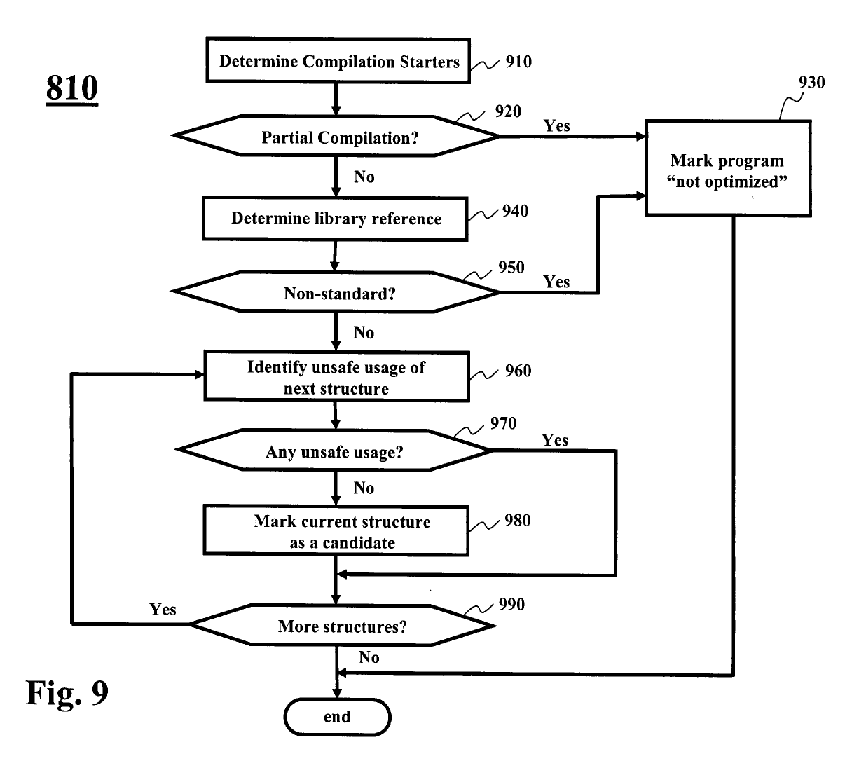

FIG. 8 is a flowchart of an exemplary process, in which the data locality of the original code 110 is optimized to produce efficient object code, according to embodiments of the inventions. Candidate structures for data locality optimization is first identified at act 810. Details related to the flow in identifying such candidates are described with reference to FIG. 9. Based on an identified candidate structure, profiling is performed at act 820. The fields of the candidate structure are then re-ordered, at act 830, according to the profile of the fields.

To optimize data locality, the candidate structure is split, at act 840, based on the re-ordered fields. Details related to the flow in structure splitting are described with reference to FIG. 10. The original code 110 is then accordingly modified, at act 850, to reflect the changes in structure layout. When all candidate structures are optimized for efficient memory access, the modified original code is compiled at act 860.

FIG. 9 is a flowchart of an exemplary process, in which a candidate structure in the original code 110 is identified to be optimized, according to embodiments of the inventions. The compilation status of the original code 110 is first determined at act 910. When the original code 110 is to be partially compiled, determined at act 920, the original code 110 is marked as, at act 930, not being optimized. If the compilation status is not partial, the library reference in the original code 110 is examined at act 940. If there is a reference to a non-standard library, determined at act 950, the original code 110 is also marked as not being optimized. Otherwise, the original code 110 can be optimized and the process proceeds to identify candidate structures to be optimized.

The unsafe usage with respect to a structure is identified at act 960. Exemplary unsafe usages of a structure are discussed with reference to FIG. 4. If no unsafe usage is identified, determined at act 970, the structure is marked, at act 980, as a candidate for optimization. The candidate selection process repeats until all structures in the original code 110 are examined, determined at act 990.

FIG. 10 is a flowchart of an exemplary process, in which a candidate structure is split into more than one structure and the original code 110 is modified to reflect the structure change, according to embodiments of the inventions. Original recorded structure layout in a symbol table is first modified, at act 1010, to reflect the changed layout of the split structures. Accordingly, references to the changed structure in the original code 110 are also modified. This includes modifications made to all structure references, performed at act 1020, modifications optionally made to pointer arithmetic, performed at act 1030, and modifications made to structure allocations in the original code 110, performed at act 1040.

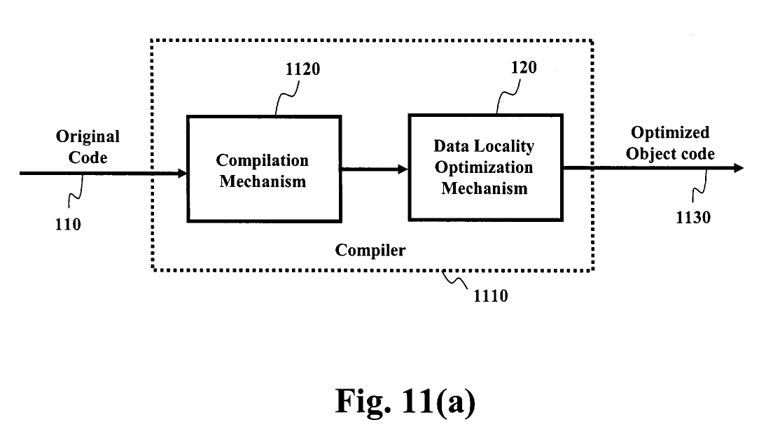

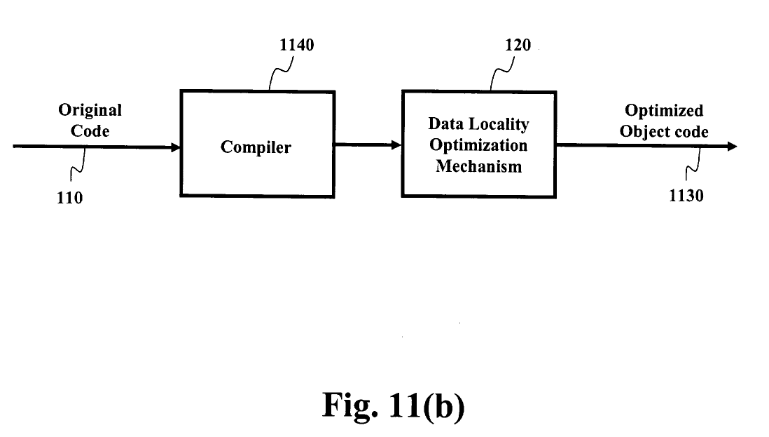

FIGS. 11(a) and (b) depict different schemes in which the described data locality optimization is utilized in conjunction with a compiler to generate object code from the original code 110 programmed in a non-type-safe language, according to embodiments of the inventions. FIG. 11(a) describes a first embodiment, in which the data locality optimization mechanism 120 is deployed as a part of the compiler 1110 and performs data locality optimization after a compilation mechanism 1120 has compiled the original code 110.

FIG. 11(b) depicts a different embodiment, in which the data locality optimization mechanism 120 is an operative mechanism, independent of a compiler 1140. The original code 110 is fed to the compiler 1140 first. The output of the compiler 1140 is then fed to the data locality optimization mechanism 120 to be optimized. These two different schemes of utilizing data locality optimization mechanism 120 may require the data locality optimization mechanism 120 to be implemented differently. For example, in using the scheme described in FIG. 11(b), the only information that is accessible to the data locality optimization mechanism 120 may be limited to the output of the compiler 1140. Yet, according to the scheme described in FIG. 11(a), the data locality optimization mechanism 120 may be able to access different intermediary results of the compilation mechanism 1120. Although different implementations, the basic principles of data locality optimization for a non-type-safe programming language are the same as what is described above.

While the invention have been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims. optimization mechanism 120 is deployed as a part of the compiler 1110 and performs data locality optimization after a compilation mechanism 1120 has compiled the original code 110.

FIG. 11(b) depicts a different embodiment, in which the data locality optimization mechanism 120 is an operative mechanism, independent of a compiler 1140. The original code 110 is fed to the compiler 1140 first. The output of the compiler 1140 is then fed to the data locality optimization mechanism 120 to be optimized. These two different schemes of utilizing data locality optimization mechanism 120 may require the data locality optimization mechanism 120 to be implemented differently. For example, in using the scheme described in FIG. 11(b), the only information that is accessible to the data locality optimization mechanism 120 may be limited to the output of the compiler 1140. Yet, according to the scheme described in FIG. 11(a), the data locality optimization mechanism 120 may be able to access different intermediary results of the compilation mechanism 1120. Although different implementations, the basic principles of data locality optimization for a non-type-safe programming language are the same as what is described above.

While the invention have been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
identifying a candidate structure in original code programmed in a non-type-safe language; and
optimizing the data locality of the candidate structure in the original code, if the same is identified in the identifying, to produce optimized code.

2. The method according to claim 1, wherein the identifying comprises:
determining whether the original code can be optimized based on at least one of a compilation status and a library reference in the original code; and
determining, if the original code can be optimized, the candidate structure according to at least one criterion, wherein the at least one criterion is related to the candidate structure.

3. The method according to claim 2, wherein the at least one criterion includes:
existing aliasing in the candidate structure;
usage of the address of a field of the candidate structure;
access to the candidate structure through a type-cast pointer;
access inside of the candidate structure through a pointer arithmetic involving a pointer to the candidate structure;
passing of a pointer to the candidate structure to an unsafe function;
the candidate structure being a field of a disabled structure;
a field of the candidate structure being a field of a disabled structure; and
a field of the candidate structure being an array object.

4. The method according to claim 1, wherein the optimizing comprises:
profiling the fields within the candidate structure to derive a profile for the candidate structure;
re-ordering the fields according to the profile of the candidate structure;
splitting the candidate structure based on the re-ordered fields of the candidate structure to produce more than one split structure; and
modifying the original code based on the split structures.

5. The method according to claim 1, further comprising compiling the optimized code to generate object code.

6. A method for optimizing data locality, comprising:
identifying a candidate structure in original code programmed in a non-type-safe language; and
profiling the fields within the candidate structure to derive a profile for the candidate structure;
changing the structure layout of the candidate structure according to the profile to optimize the data locality.

7. The method according to claim 6, wherein the identifying comprises:
determining whether the original code can be optimized based on at least one global criterion; and
determining, if the original code can be optimized, the candidate structure according to at least one local criterion, wherein the at least one local criterion related to the candidate structure.

8. The method according to claim 7, wherein the at least one global criterion includes:
a delta compilation status of the original code; and
a reference in the original code to a non-standard library.

9. The method according to claim 7, wherein the at least one local criterion includes:
existing aliasing in the candidate structure;
usage of the address of a field of the candidate structure;
access to the candidate structure through a type-cast pointer;
access inside of the candidate structure through a pointer arithmetic involving a pointer to the candidate structure;
passing of a pointer to the candidate structure to an unsafe function;
the candidate structure being a field of a disabled structure;
a field of the candidate structure being a field of a disabled structure; and
a field of the candidate structure being an aggregated object.

10. The method according to claim 6, wherein the changing the structure layout comprises:
re-ordering the fields of the candidate structure according to the profile of the candidate structure;
splitting the candidate structure based on the re-ordered fields of the candidate structure to produce more than one split structures; and
modifying the original code based on the split structures.

11. The method according to claim 10, wherein the modifying comprises:
modifying a reference to the candidate structure in the original code; and
modifying memory allocation associated with the candidate structure in the original code.

12. A system comprising:
original code programmed in a non-type-safe language;
a data locality optimization mechanism capable of optimizing the data locality of a candidate structure in the original code to produce optimized code.

13. The system according to claim 12, wherein the data locality optimization mechanism comprises:
a candidate structure identifier capable of identifying the candidate structure;
a profiling mechanism capable of producing a profile of the candidate structure;
a field re-ordering mechanism capable of re-ordering the fields of the candidate structure according to the profile; and
a structure splitting mecanism capable of splitting the candidate structure into more than one split structures.

14. The system according to claim 13, wherein the structure splitting mechanism comprises:
a structure layout modification mchanism capable of changing the structure layout of the candidate structure to the layout of the split structures;
a code modification mechanism capable of modifying the original code based on the layout of the split structures.

15. The system according to claim 12, further comprising a compiler capable of compiling the optimized code to generate object code.

16. A system for optimizing data locality, comprising:
a candidate structure identifier capable of identifying the candidate structure;
a profiling mechanism capable of producing a profile of the candidate structure;
a field re-ordering mechanism capable of re-ordering the fields of the candidate structure according to the profile; and
a structure splitting mecanism capable of splitting the candidate structure into more than one split structures.

17. The system according to claim 16, wherein the candidate structure identifier comprises:
a compilation status analyzer capable of recognizing the compilation status of the original code;
a library reference analyzer capable of identifying a reference to a non-standard library in the original code;
an unsafe usage determiner capable of determining unsafe usage with respect to the candidate structure; and
a candidate selection mechanism capable of selecting the candidate structure based on identified unsafe usage according to at least one local criterion.

18. The system according to claim 16, wherein the structure splitting mechanism comprises:
a structure layout modification mchanism capable of changing the structure layout of the candidate structure to the layout of the split structures;
a code modification mechanism capable of modifying the original code based on the layout of the split structures.

19. The system according to claim 18, wherein the code modification mechanism comprises:
a structure reference modification mechanism capable of modifying a reference to the candidate structure in the original code; and
a structure allocation modification mechanism capable of modifying memory allocation associated with the candidate structure in the original code.

20. An article comprising a storage medium having stored thereon instructions that, when executed by a machine, result in the following:
identifying a candidate structure in original code programmed in a non-type-safe language; and
optimizing the data locality of the candidate structure in the original code, if the same is identified in the identifying, to produce optimized code.

21. The article according to claim 20, wherein the identifying comprises:
determining whether the original code can be optimized based on at least one of a compilation status and a library reference in the original code; and
determining, if the original code can be optimized, the candidate structure according to at least one criterion, wherein the at least one criterion is related to the candidate structure.

22. The article according to claim 21, wherein the at least one criterion includes:
existing aliasing in the candidate structure;
usage of the address of a field of the candidate structure;
access to the candidate structure through a type-cast pointer;
access inside of the candidate structure through a pointer arithmetic involving a pointer to the candidate structure;
passing of a pointer to the candidate structure to an unsafe function;
the candidate structure being a field of a disabled structure;
a field of the candidate structure being a field of a disabled structure; and
a field of the candidate structure being an array object.

23. The article according to claim 20, wherein the optimizing comprises:
profiling the fields within the candidate structure to derive a profile for the candidate structure;
re-ordering the fields according to the profile of the candidate structure;
splitting the candidate structure based on the re-ordered fields of the candidate structure to produce more than one split structure; and
modifying the original code based on the split structures.

24. The article according to claim 20, the instructions, when executed, further result in compiling the optimized code to generate object code.

25. An article comprising a storage medium having stored thereon instructions for optimizing data locality that, when executed by a machine, result in the following:
identifying a candidate structure in original code programmed in a non-type-safe language; and
profiling the fields within the candidate structure to derive a profile for the candidate structure;
changing the structure layout of the candidate structure according to the profile to optimize the data locality.

26. The article according to claim 25, wherein the identifying comprises:
determining whether the original code can be optimized based on at least one global criterion; and
determining, if the original code can be optimized, the candidate structure according to at least one local criterion, wherein the at least one local criterion related to the candidate structure.

27. The article according to claim 26, wherein the at least one global criterion includes:
a delta compilation status of the original code; and
a reference in the original code to a non-standard library.

28. The article according to claim 26, wherein the at least one local criterion includes:
existing aliasing in the candidate structure;
usage of the address of a field of the candidate structure;
access to the candidate structure through a type-cast pointer;
access inside of the candidate structure through a pointer arithmetic involving a pointer to the candidate structure;
passing of a pointer to the candidate structure to an unsafe function;
the candidate structure being a field of a disabled structure;
a field of the candidate structure being a field of a disabled structure; and
a field of the candidate structure being an aggregated object.

29. The article according to claim 25, wherein the changing the structure layout comprises:
re-ordering the fields of the candidate structure according to the profile of the candidate structure;
splitting the candidate structure based on the re-ordered fields of the candidate structure to produce more than one split structures; and
modifying the original code based on the split structures.

30. The article according to claim 29, wherein the modifying comprises:
modifying a reference to the candidate structure in the original code; and
modifying memory allocation associated with the candidate structure in the original code.
